(19) United States
(12) Patent Application Publication
(10) Pub. No.: US 2026/0106252 A1
(43) Pub. Date: Apr. 16, 2026

(54) ELECTRICITY STORAGE MODULE AND METHOD OF DISASSEMBLING ELECTRICITY STORAGE MODULE

(71) Applicant: TOYOTA JIDOSHA KABUSHIKI KAISHA, Toyota-shi (JP)

(72) Inventors: Kazuhito KATO, Toyota-shi (JP); Tomohiro Yokoyama, Toyota-shi (JP); Seigo Fujishima, Toyota-shi (JP); Nariaki Miki, Okazaki-shi (JP); Satoshi Morioka, Okazaki-shi (JP); Takeshi Abe, Toyota-shi (JP); Masashi Kato, Konan-shi (JP)

(73) Assignee: TOYOTA JIDOSHA KABUSHIKI KAISHA, Toyota-shi (JP)

(21) Appl. No.: 19/254,281

(22) Filed: Jun. 30, 2025

(30) Foreign Application Priority Data
Oct. 11, 2024 (JP) 2024-179234

(51) Int. Cl. H01M 10/54; H01M 4/02; H01M 4/70; H01M 50/414; H01M 50/46

(52) U.S. Cl. CPC H01M 10/54; H01M 4/70; H01M 50/414; H01M 50/46; H01M 2004/029

(57) ABSTRACT

An electricity storage module includes a bipolar electrode having a positive-electrode active material provided on a first surface of a current collector foil and a negative-electrode active material provided on a second surface of the current collector foil, an electrode laminated body having a plurality of the bipolar electrodes laminated therein, and a sealing portion made of a resin. The sealing portion is provided in a peripheral edge portion of the current collector foil and seals a place between the bipolar electrodes adjacent to each other in the lamination direction of the electrode laminated body. The sealing portion has a depressed portion that provides a gap between the peripheral edge portions of the current collector foils adjacent to each other in the lamination direction.

### CROSS-REFERENCE TO RELATED APPLICATION

This application claims priority to Japanese Patent Application No. 2024-179234 filed on Oct. 11, 2024. The disclosure of the above-identified application, including the specification, drawings, and claims, is incorporated by reference herein in its entirety.

### BACKGROUND

### 1. Technical Field

The present disclosure relates to an electricity storage module and a method of disassembling the electricity storage module.

### 2. Description of Related Art

Japanese Unexamined Patent Application Publication No. 2022-114963 (JP 2022-114963 A) discloses a method of disassembling an electricity storage module, separating a bipolar electrode, cooling the entire bipolar electrode, and separating a current collector, a substrate, and an adhesive as a method of disassembling an electricity storage module. In the configuration described in JP 2022-114963 A, the cooling temperature of the bipolar electrode is set to a temperature at which the current collector and the substrate are peeled off from the adhesive in accordance with a difference in the linear coefficient of expansion between the current collector, the substrate, and the adhesive.

### SUMMARY

When an electricity storage module is recycled, cells are disassembled for the purpose of collecting an electrolytic solution and bipolar electrodes in the cells. At this time, a way of removing a sealing portion that is made of a resin and that forms an outer frame of the electricity storage module and opening the cells can be conceived. In this case, when a place on the inner side relative to the outer frame of the electricity storage module is cut such that the sealing portion is cut off, the whole peripheral edge portion of a current collector foil is cut, and a part of the current collector foil is included in a cut-off piece. In order to collect the current collector foil from the cut-off piece, combustion and separation are necessary, and the number of processes increases.

The present disclosure has been made in view of the situation described above, and an object thereof is to provide an electricity storage module that inhibits the increase of processes at the time of recycling and the like and that is able to be easily disassembled and a method of disassembling the electricity storage module.

The present disclosure is an electricity storage module including a bipolar electrode, an electrode laminated body, and a sealing portion. The bipolar electrode has a positive-electrode active material provided on a first surface of a current collector foil and a negative-electrode active material provided on a second surface of the current collector foil. The electrode laminated body has a plurality of the bipolar electrodes laminated therein. The sealing portion is made of a resin, provided in a peripheral edge portion of the current collector foil, and seals a place between the bipolar electrodes that are adjacent to each other in the lamination direction of the electrode laminated body. In the electricity storage module, the sealing portion has a depressed portion that provides a gap between the peripheral edge portions of the current collector foils adjacent to each other in the lamination direction.

In the present disclosure, it is possible to inhibit the increase of processes at the time of recycling and easily perform disassembling.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an external view showing an electricity storage module in an embodiment;

FIG. 2 is a sectional view showing a structure in which current collector foils and sealing portions are laminated;

FIG. 3 is a view for describing members configuring the electricity storage module;

FIG. 4 is a view showing a protrusion and depression shape of a sealant film;

FIG. 5 is a flowchart diagram showing a method of disassembling the electricity storage module;

FIG. 6 is a view for describing a state in which cracks have occurred in the sealing portions;

FIG. 7 is a view for describing a state in which a resin of the sealing portions is crushed at the time of cooling pressing; and

FIG. 8 is a view for describing one example of a cooling disassembling step.

### DETAILED DESCRIPTION OF EMBODIMENTS

An electricity storage module and a method of disassembling the electricity storage module in an embodiment of the present disclosure are specifically described below. The present disclosure is not limited to the embodiment described below.

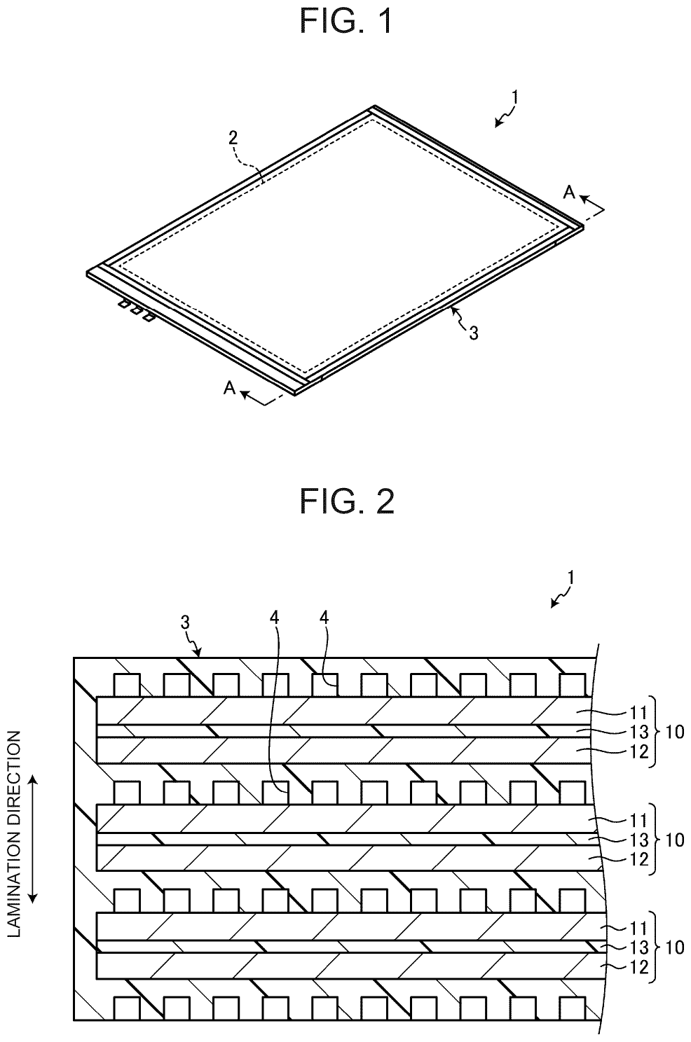

FIG. 1 is a view showing the electricity storage module in the embodiment. An electricity storage module 1 is used for a battery of a vehicle such as a plug-in hybrid electric vehicle or a battery electric vehicle. The electricity storage module 1 is a lithium-ion battery and configures a bipolar storage battery. The bipolar storage battery is a battery pack in which a plurality of the electricity storage modules 1 is laminated. The bipolar storage battery including the electricity storage modules 1 is a bipolar lithium-ion battery.

The electricity storage module 1 has a structure in which a plurality of cells is laminated. The electricity storage module 1 includes an electrode laminated body 2 in which a plurality of electrodes is laminated, and a sealing portion 3 that seals the electrode laminated body 2. The sealing portion 3 is formed as a frame body that forms an external frame of the electricity storage module 1.

The electrode laminated body 2 has a structure in which a plurality of bipolar electrodes, a positive-electrode terminal-end electrode, a negative-electrode terminal-end electrode, and a plurality of separators are laminated. Each bipolar electrode includes a current collector foil 10, a positive-electrode active material, and a negative-electrode active material. The bipolar electrode has the positive-electrode active material provided on a first surface of the current collector foil 10 and the negative-electrode active material provided on a second surface of the current collector foil 10. The positive-electrode terminal-end electrode includes a terminal-end positive-electrode foil, and a terminal-end positive-electrode active material provided on one surface of the terminal-end positive-electrode foil. The negative-electrode terminal-end electrode includes a terminal-end negative-electrode foil, and a terminal-end negative-electrode active material provided on one surface of the terminal-end negative-electrode foil. The bipolar electrodes and the separators are alternately laminated between the positive-electrode terminal-end electrode and the negative-electrode terminal-end electrode. In the bipolar electrodes adjacent to each other in the lamination direction, the positive-electrode active material of one bipolar electrode is laminated on the negative-electrode active material of the other bipolar electrode across the separator.

As shown in FIG. 2, the current collector foil 10 is a current collector in which an aluminum foil 11 and a copper foil 12 are adhered to each other via an adhesive layer 13. In other words, the current collector foil 10 is a laminated foil. The aluminum foil 11 is a positive-electrode base material (positive electrode foil). The copper foil 12 is a negative-electrode base material (negative electrode foil). The adhesive layer 13 is a resin layer that causes the aluminum foil 11 and the copper foil 12 to adhere to each other. The adhesive layer 13 includes an epoxy resin.

A first surface of the aluminum foil 11 is adhered to the copper foil 12 via the adhesive layer 13. The positive-electrode active material is provided on a second surface of the aluminum foil 11. The external form of the positive-electrode active material is smaller than the external form of the aluminum foil 11. The second surface of the aluminum foil 11 includes an uncoated portion. The uncoated portion is a region in which the positive-electrode active material is not provided. The uncoated portion is positioned in a peripheral edge portion of the aluminum foil 11. The peripheral edge portion of the aluminum foil 11 is a peripheral edge portion of the current collector foil 10.

A first surface of the copper foil 12 is adhered to the aluminum foil 11 via the adhesive layer 13. The negative-electrode active material is provided on a second surface of the copper foil 12. The external form of the negative-electrode active material is smaller than the external form of the copper foil 12. The second surface of the copper foil 12 includes an uncoated portion. The uncoated portion is a region in which the negative-electrode active material is not provided. The uncoated portion is positioned in a peripheral edge portion of the copper foil 12. The peripheral edge portion of the copper foil 12 is a peripheral edge portion of the current collector foil 10.

The cell is configured by the electrode laminated body 2, the sealing portion 3, and an electrolytic solution. The cells adjacent to each other in the lamination direction shares one bipolar electrode and are electrically connected to each other in series via the bipolar electrode. The electrolytic solution is accommodated in a space partitioned by the current collector foils 10 adjacent to each other in the lamination direction and the sealing portion 3 positioned between those current collector foils 10. The electrolytic solution is also accommodated in a space partitioned by the bipolar electrode, the positive-electrode terminal-end electrode, and the sealing portion 3 positioned between the bipolar electrode and the positive-electrode terminal-end electrode. Similarly, the electrolytic solution is also accommodated in a space partitioned by the bipolar electrode, the negative-electrode terminal-end electrode, and the sealing portion 3 positioned between the bipolar electrode and the negative-electrode terminal-end electrode.

The sealing portion 3 is a sealing member that is provided in the peripheral edge portion of the current collector foil 10 and is disposed so as not to come into contact with the positive-electrode active material and the negative-electrode active material. The sealing portion 3 is configured by a resin having an insulation property. As the material configuring the sealing portion 3, resin materials such as polypropylene (PP), polyethylene (PE), polyphenylene sulfide (PPS), polystyrene (PS), an ABS resin, and an AS resin can be used. For example, the sealing portion 3 is configured by a composite of polypropylene, polyethylene, and polyphenylene sulfide.

The electricity storage module 1 has a structure in which the peripheral edge portions of the current collector foils 10 are laminated by a plurality of resins. In other words, the sealing portion 3 is configured by a plurality of sealing members. As shown in FIG. 2, the sealing portion 3 has depressed portions 4 each forming a gap between the peripheral edge portions of the current collector foils 10 adjacent to each other in the lamination direction.

The depressed portion 4 is formed in a shape depressed in the lamination direction and is provided in the sealing portion 3 by a plurality of numbers. The depressed portions 4 are provided along the peripheral edge portion of the current collector foil 10 in positions that overlap with the peripheral edge portion of the current collector foil 10. The depressed portions 4 are provided across the entire periphery of the frame body obtained by the sealing portion 3.

The depressed portions 4 are provided in at least one of the sealing members configuring the sealing portion 3. For example, the depressed portions 4 are provided in a first sealing member that is in contact with a surface of the peripheral edge portion of the current collector foil 10 out of the sealing members. In the example shown in FIG. 2, the depressed portions 4 are provided in the first sealing member that is in contact with the aluminum foil 11. Those depressed portions 4 are provided in a surface that is in contact with the surface of the peripheral edge portion of the aluminum foil 11 out of the first sealing member.

The sealing portion 3 has a structure in which protrusions and depressions are provided in a part of the resin in the peripheral edge portion of the current collector foil 10 and stress is concentrated in the depressed portions 4 and the resin is easily broken at the time of cooling pressing. As a result of the sealing portion 3 including the depressed portions 4, stress is concentrated in parts with a thin resin, cracks are generated from those parts serving as starting points, and the resin drops at the time of cooling pressing. The place that is heated and laminated is an end portion on the outer side relative to the current collector foil 10. Therefore, heat is not transmitted to a place on the inner side relative to the end portion, and a protrusion and depression structure remains. Gaps remain in the sealing portion 3, and hence the starting points of the breakages at the time of the cooling pressing can be secured.

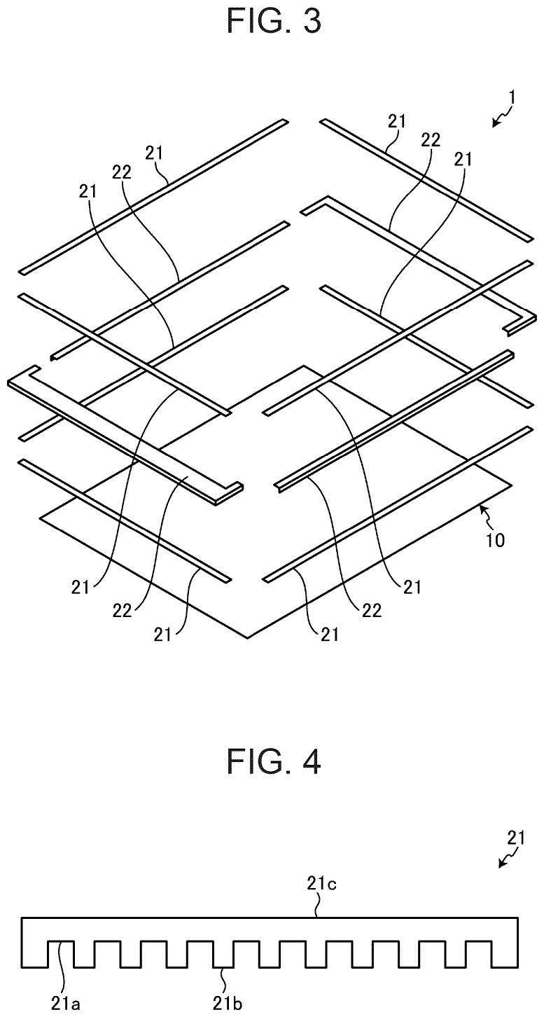

As shown in FIG. 3, in the electricity storage module 1, a plurality of resins such as seals, spacers, the sealant films 21, and terminal housings is provided in the peripheral edge portion of the current collector foil 10, and those resins are welded by the laminate films 22. The sealing portion 3 includes seals (first sealing members), the spacers, the sealant films 21, the terminal housings, and the laminate films 22.

The sealant films 21 are configured by a polypropylene resin. The sealant films 21 are disposed so as to cover the peripheral edge portion of the current collector foil 10 across four edges of the entire periphery thereof. As shown in FIG. 4, each sealant film 21 has one surface formed in a protrusion and depression shape. The sealant film 21 includes a protrusion and depression surface 21b in which the depressed portions 21a are provided and a planar surface 21c. It is possible to employ a structure in which a part of the sealant film 21 has protrusions and depressions.

The laminate films 22 include a polypropylene resin. The laminate films 22 are welded to the sealant films 21. Each laminate film 22 is provided on the outer side of the sealant film 21 in a direction orthogonal to the lamination direction.

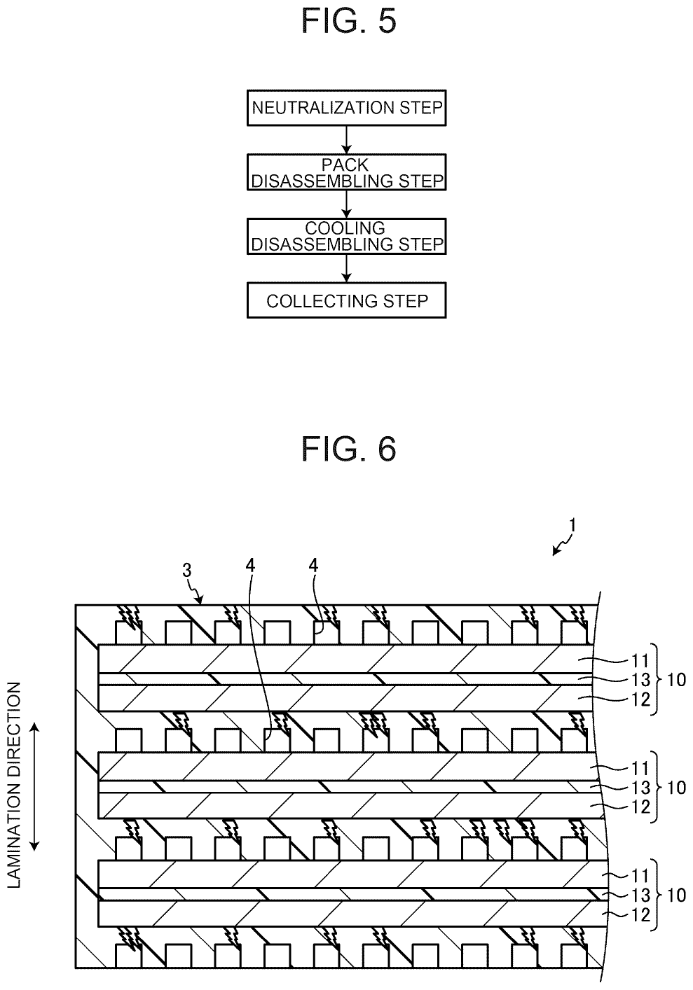

FIG. 5 is a flowchart diagram showing a method of disassembling the electricity storage module. The method of disassembling of the electricity storage module 1 includes a neutralization step (Step S1), a pack disassembling step (Step S2), a cooling disassembling step (Step S3), and a collecting step (Step S4).

The neutralization step is a step of discharging a battery pack such that the battery pack can be safely handled (Step S1). The neutralization step includes a discharging step of discharging the battery pack. The battery pack is a bipolar storage battery including the electricity storage modules 1.

The pack disassembling step is a step of disassembling the battery pack and separating the electricity storage modules 1 from components of the battery pack (Step S2). In the disassembling step, a structure in which the electricity storage modules 1 are laminated is disassembled, and the electricity storage modules 1 are separated in units of the electricity storage modules 1.

The cooling disassembling step is a step of crushing the sealing portion 3 by applying stress to the sealing portion 3 in a state in which the sealing portion 3 is cooled (Step S3). In the cooling disassembling step, the cooling and disassembling are performed for each electricity storage module 1 such that separation from the electricity storage module 1 can be performed for each bipolar electrode. In the cooling disassembling step, the electricity storage module 1 is cooled, and the sealing portion 3 provided on four edges of the electricity storage module 1 is removed. The cooling disassembling step includes a cooling step of concentratively cooling the sealing portion 3, a pressing step of applying stress to the sealing portion 3 in a cooling environment, and a collecting step of collecting the crushed sealing portion 3.

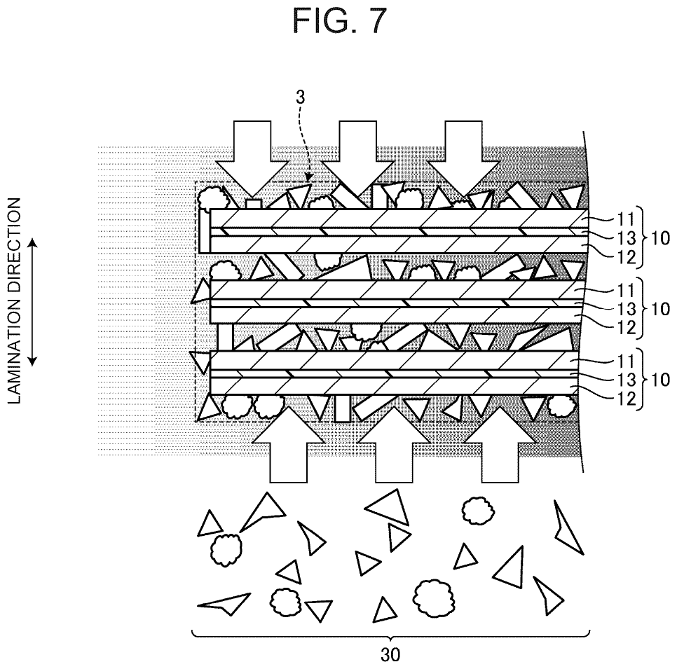

In the cooling step of the cooling disassembling step, the electricity storage module 1 is cooled such that low-temperature embrittlement of the resin of the sealing portion 3 occurs. In the cooling step, the electricity storage module 1 is cooled to −60° C. or less. In the pressing step of the cooling disassembling step, the electricity storage module 1 in a cooled state is pressed in the lamination direction and frozen crushing of the sealing portion 3 is performed. In the pressing step, the frozen crushing of the sealing portion 3 is performed by intentionally applying stress to the sealing portion 3 of which low-temperature embrittlement has occurred by cooling. As shown in FIG. 6, at the time of cooling pressing, stress is concentrated in parts with thin resins in the sealing portion 3, and cracks are generated from the parts serving as a starting point. As a result of pressing the sealing portion 3 in the lamination direction in a state in which cracks are generated in the sealing portion 3 from the gaps obtained by the depressed portions 4 serving as the starting points, the resin of the sealing portion 3 breaks, and the broken resin 30 falls down as shown in FIG. 7. In FIG. 7, the state of being in the cooling environment and arrows indicating the directions in which the pressing load by the pressing step is applied are shown.

The collecting step is a step of collecting an electrolytic solution filling the place between the bipolar electrodes by heating and reduced-pressure drying and the like (Step S4). In the collecting step, the electrolytic solution contained in laminates, the bipolar electrodes, and the separators that are components remaining after the cooling disassembling step is collected by performing reduced-pressure drying of the electrolytic solution.

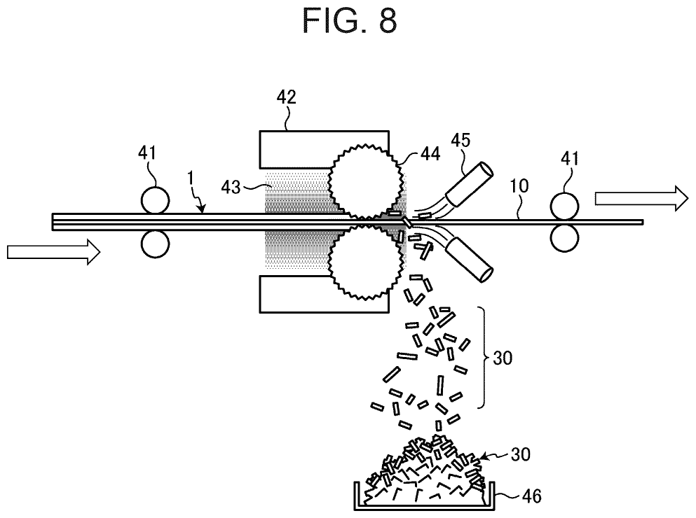

FIG. 8 is a view showing one example of the cooling disassembling step. In the cooling disassembling step, the cooling step, the pressing step, and the collecting step are performed while the electricity storage module 1 obtained by the pack disassembling step is conveyed by a pinch roll 41.

In the cooling step, the overall electricity storage module 1 is cooled by forced cooling, contact cooling, or the like. In the cooling step, the electricity storage module 1 is cooled to −60° C. or less. For example, the cooling step can include a step of spraying frozen solvent such as liquid nitrogen (−196° C.) and dry ice (−79° C.) to the electricity storage module 1 or a step of bringing a cooled member into contact with the electricity storage module 1. In the cooling step, the frozen solvent 43 is sprayed to the overall electricity storage module 1 by the cooling apparatus 42. In the cooling step, there is no need to evenly cool the electricity storage module 1 to the inside thereof. When the sealing portion 3 can be cooled from an outer peripheral part to the inner side across a predetermined range, the low-temperature embrittlement of the resin configuring the sealing portion 3 can be performed.

In the pressing step, the electricity storage module 1 in the cooling state is pressed in the lamination direction. In the pressing step, frozen crushing of the sealing portion 3 is performed by pressing the overall electricity storage module 1 by a pressing apparatus 44. In the pressing step, the pressing apparatus 44 that can press a contact portion while cooling the contact portion by a press die having a shape that can press a part of the sealing portion 3 or simultaneously press four edges of the sealing portion 3 is used.

In an example shown in FIG. 8, the pressing apparatus 44 has a pair of press rollers. The press rollers are sufficiently cooled rollers and press the electricity storage module 1 so as to sandwich the electricity storage module 1 in the lamination direction. For example, the press rollers are cooled by the cooling step. In the pressing apparatus 44, the electricity storage module 1 is conveyed with use of the pinch roll 41. The pressing apparatus 44 presses the electricity storage module 1 by the press roller while conveying the electricity storage module 1. For example, the press rollers have roller surfaces each formed in a protrusion and depression shape so as to transmit stress to the inside of the sealing portion 3. The sealing portion 3 can be crushed by the protrusions and depressions of the surfaces of the press rollers.

In the collecting step, the sealing portion 3 that is embrittled by cooling and stress breaks and drops. As a result, the resin 30 is collected. In the collecting step, external force is applied to the electricity storage module 1 after the pressing step by air blowing using air blowers 45, application of vibration, or the like, and the crushed resin 30 is collected. In the example shown in FIG. 8, the air blowers 45 and a pan 46 are provided downstream of the press rollers of the pressing apparatus 44. The resin 30 is separated from the bipolar electrode and falls down by the air blown by the air blowers 45. In the collecting step, the resin 30 that has fallen down is collected by the pan 46. When liquid nitrogen is used in the cooling step, the liquid nitrogen and the like volatilize while the resin 30 is falling down. By the pan 46, it is possible to remove components and the like of the electrolytic solution and collect only carbon components by returning the crushed sealing portion 3 to normal temperature and washing the crushed sealing portion 3 with water (washing the crushed sealing portion 3 with acid). At this time, the resin 30 can be collected by removing salt by immersing the sealing portion 3 in water by a screen and the like. The resin 30 can be collected in a safer manner by putting an excess amount of water in the pan 46 in advance by assuming that the electrolytic solution is adhering to the resin 30 that has fallen down. In this case, when a mildly acidic solution is used instead of water, lithium carbonate and the like that are generated after deterioration can also be dissolved, and it is possible to perform solid-liquid separation of only the resin 30.

The resin 30 obtained by the collecting step can become a raw material of a molding material again as resin pieces and can be recycled to become a material. Aluminum and copper cannot be crushed by the toughness of metal, the adhesive layer 13 of the current collector foil 10 is an epoxy resin, and the thermal resistance of an epoxy resin is −268° C. and is extremely low. Therefore, it is possible to efficiently collect only the electrodes.

In the cooling disassembling step, the sealing portion 3 embrittled by the cooling is crushed, but it is not a problem even when not all of the resin configuring the sealing portion 3 can be collected. By the cooling disassembling step, not only can the electrodes be separated for each current collector foil 10, but opening portions for collecting the electrolytic solution can also be secured. As a result of the opening portions being formed by the cooling disassembling step, the electrolytic solution can be collected by performing reduced-pressure drying in the next step.

By the cooling disassembling step, the electricity storage module 1 can be disassembled in a non-roasting manner. By performing the cooling disassembling step, the resin configuring the sealing portion 3 can be collected in a crushed state and can be used as a recycled raw material. There is a fear that the electrolytic solution may be adhering to the collected resin 30. Therefore, usage as a raw material is facilitated by performing washing with water in a weakly acidic state and performing washing with water by also dissolving solid salt such as lithium carbonate.

As described above, with the embodiment, the resin forming the outer frame of the electricity storage module 1 and the current collector foils 10 can be easily separated from each other by the depressed portions 4 provided in the sealing portion 3. As a result, it is possible to easily disassemble the electricity storage module 1. It is possible to disassemble the electricity storage module 1 without affecting the current collector foils 10, a positive electrode, and a negative electrode and collect a resin of which material recycling is possible.

In the current collector foil 10, a combination of metallic foils configuring the positive electrode foil and the negative electrode foil is not limited to a combination of the aluminum foil 11 and the copper foil 12. The metallic foil included in the current collector foil 10 may be a lead foil. The bipolar storage battery including the current collector foil 10 is not limited to a bipolar lithium-ion battery and may be a bipolar lead storage battery or a bipolar nickel hydride battery.

The surface in which the depressed portions 4 are provided in the sealing member is not particularly limited. The depressed portions 4 may be provided in either surface of the sealing member or may be provided in both surfaces of the sealing member. For example, when the depressed portions 4 are provided in the first sealing member, the depressed portions 4 are not limited to being provided in a surface on the side that is in contact with the current collector foil 10 and may be provided in a surface on the side that is not in contact

### With the Current Collector Foil 10.

The depressed portions 4 are not limited to being provided in the sealing portion 3 disposed to be interposed between the current collector foils 10 adjacent to each other in the lamination direction and may be provided in the sealing portion 3 disposed in the outer side relative to the positive-electrode terminal-end electrode in the lamination direction or may be disposed on the outer side relative to the negative-electrode terminal-end electrode in the lamination direction. For example, in the electricity storage module 1, the sealant film 21 may be formed in a protrusion and depression shape. In short, in the electricity storage module 1, the depressed portions 4 only need to be provided in a resin of a part of the sealing portion 3 that is provided in a position that overlaps with the peripheral edge portion of the current collector foil 10 when the electricity storage module 1 is seen from the lamination direction.

What is claimed is:

1. An electricity storage module, comprising:
a bipolar electrode having a positive-electrode active material provided on a first surface of a current collector foil and a negative-electrode active material provided on a second surface of the current collector foil;
an electrode laminated body having a plurality of the bipolar electrodes laminated in the electrode laminated body; and
a sealing portion made of a resin, the sealing portion being provided in a peripheral edge portion of the current collector foil, the sealing portion sealing a place between the bipolar electrodes that are adjacent to each other in a lamination direction of the electrode laminated body, wherein the sealing portion has a depressed portion that provides a gap between the peripheral edge portions of the current collector foils adjacent to each other in the lamination direction.

2. The electricity storage module according to claim 1, wherein:
the sealing portion is configured by a plurality of sealing members; and
the depressed portion is provided in at least one of the sealing members.

3. The electricity storage module according to claim 2, wherein:
the current collector foil is a current collector having a positive electrode foil and a negative electrode foil that are adhered to each other via an adhesive layer; and
the depressed portion is provided in at least a first sealing member that is in contact with the peripheral edge portion of the current collector foil out of the sealing members.

4. The electricity storage module according to claim 3, wherein the depressed portion is provided in a shape depressed in the lamination direction and is provided in a surface that is in contact with the peripheral edge portion of the current collector foil out of the first sealing member.

5. A method of disassembling the electricity storage module according to claim 1, the method comprising cooling disassembling of performing frozen crushing of the sealing portion by cooling the sealing portion to −60° C. or less and pressing the sealing portion in the lamination direction.
